(19) United States
(12) Patent Application Publication
(10) Pub. No.: US 2026/0154693 A1
(43) Pub. Date: Jun. 4, 2026

(54) SYSTEMS AND METHODS FOR AI/ML-BASED PAIRING OF SUPPORT REQUESTS TO SUPPORT AGENTS

(71) Applicant: Verizon Patent and Licensing Inc., Basking Ridge, NJ (US)

(72) Inventors: Balakrishnan Palanisamy, Namakkal District (IN); Ravikiran Chekuri, Farmers Branch, TX (US); Rajkumar Bondugula, Coppell, TX (US); Mayuresh Mohan Hegde, Coppell, TX (US)

(73) Assignee: Verizon Patent and Licensing Inc., Basking Ridge, NJ (US)

(21) Appl. No.: 18/964,392

(22) Filed: Nov. 30, 2024

(51) Int. Cl. G06Q 30/015

(52) U.S. Cl. CPC G06Q 30/015

(57) ABSTRACT

A system described herein may maintain a set of requestor models and a set of support agent models; identify, for each support agent of a plurality of support agents, a corresponding support agent model; monitor a state of a queue that includes a plurality of support requests; receive a request to pair a particular support request, of the plurality of support requests, with a support agent, wherein the particular support request is received from a particular requestor; identify a particular requestor model associated with the particular support request; select, based on the particular requestor model, the particular support agent model, and the state of the queue, a particular support agent; and establish a communication session between the selected particular support agent and the particular requestor.

### BACKGROUND

Entities such as organizations, institutions, companies, or the like, may provide support services via, for example, support tickets, call centers, or the like. Such support services may include, for example, receiving support requests and providing the requests to support agents on a first-in-first-out basis. The assignment of support requests to support agents may be highly variable in terms of achieving favorable outcomes. For example, support requests that are forwarded to respective support agents on a first-in-first-out basis may not take into account specific aspects of the support requests and/or of the individuals initiating such requests, potentially leading to suboptimal outcomes. These suboptimal outcomes may affect Key Performance Indicators (“KPIs”) such as customer satisfaction, time spent resolving support requests, repeated requests for the same issue, or the like.

### BRIEF DESCRIPTION OF THE DRAWINGS

FIG. 1 illustrates an example overview of one or more embodiments described herein;

FIGS. 2 and 3 illustrate example communications between multiple layers of a support routing platform of some embodiments;

FIG. 4 illustrates an example of processing by one or more layers of a support routing platform of some embodiments;

FIG. 5 illustrates an example process for utilizing automated techniques to pair support requests with support agents, in accordance with some embodiments;

FIG. 6 illustrates an example environment in which one or more embodiments, described herein, may be implemented; and

FIG. 7 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for a multi-layered architecture that provides for intelligent routing or handling of support requests, in order to optimize factors such as lower wait times for handling requests, selecting an appropriate support agent to handle requests associated with a given requestor or requestor type, effective resolutions to support issues, measures of user satisfaction, or other suitable factors. For example, some embodiments may utilize artificial intelligence/machine learning (“AI/ML”) techniques or other suitable automated techniques to pair support requests to support agents on an intelligent and ever-evolving basis, rather than a rigid or static basis (e.g., a first-in-first-out basis). As discussed below, the AI/ML techniques may utilize factors such as content or type of support request, requestor attributes, and/or support agent attributes in order to optimally route support requests to an appropriate agent, thereby optimizing the factors noted above and/or other factors.

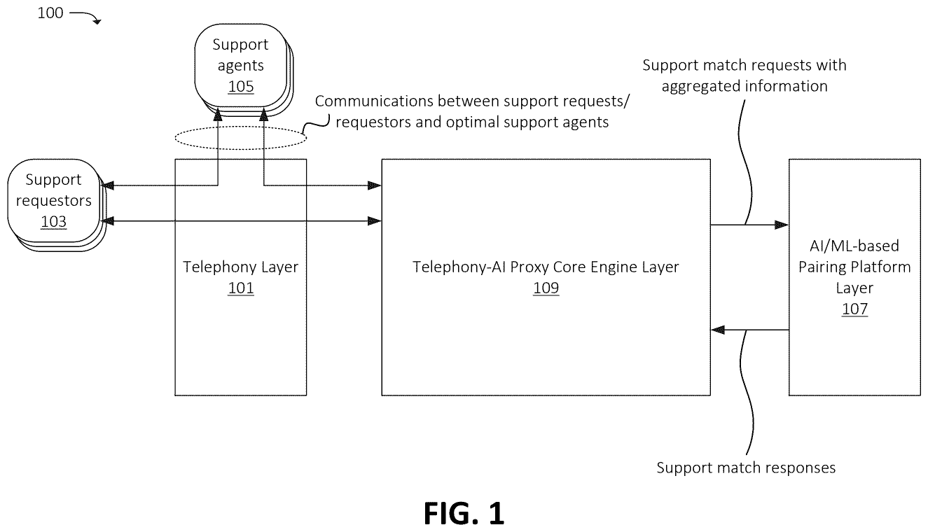

As shown in FIG. 1 and as discussed in more detail below, a multi-layered architecture 100 of some embodiments may include Telephony Layer (“TL”) 101 for handling incoming support requests (e.g., receiving support requests from support requestors 103 and/or serving as a routing interface for communications between support requestors 103 and support agents 105), AI/ML-based Pairing Platform Layer (“APPL”) 107 for matching support requests to support agents in an intelligent manner, and telephony-AI proxy core engine layer (“TAPCEL”) 109 for monitoring support agent and/or support queue status information. TAPCEL 109 may further act as a bridge between the telephony layer and the AI/ML-based pairing platform layer, as discussed below. For example, TAPCEL 109 may monitor or aggregate information associated with TL 101, support requestors 103, support agents 105, and/or other sources such as a wireless network, and may provide such information to APPL 107, along with potentially other information, such as constraints, weights, rules, etc. that may be used to further refine or configure AI/ML techniques used by APPL 107. APPL 107 may utilize AI/ML techniques or other suitable techniques to match support requests and/or support requestors 103 with optimal support agents 105.

As discussed herein, APPL 107 may execute models, such as AI/ML models that utilize AI/ML techniques or algorithms such as CatBoost regression, linear regression, deep learning, or the like, that are trained based on historical information such as previous support requests and their outcomes, attributes associated with respective support requestors 103 (e.g., requestor models), attributes associated with respective support agents 105 (e.g., agent models), and/or other suitable information. APPL 107 may utilize such techniques to select pairings of support requestors 103 to support agents 105 (e.g., to handle support requests associated with or received from such support requestors 103), in order to optimizing outcomes such as user satisfaction of support requestors 103, reduce resolution time of support requests, reduce the likelihood of transferring requests between support agents 105, reduce the likelihood of “burnout” or reduced performance by support agents 105, and/or other suitable measures of optimization.

TAPCEL 109 may provide or implement application programming interfaces (“APIs”), software development kits (“SDKs”), frameworks, adapters, or other suitable interfaces based on which TAPCEL 109 may communicate with various systems, such as TL 101, support agent 105, information sources, and/or other devices or systems. TAPCEL 109 may include an in-memory cache to maintain real-time state data relating to support agents 105, queue status information (e.g., queued support requests from one or more support requestors 103), and/or other suitable information. In some embodiments, TAPCEL 109 may implement “default” or “fallback” pairing rules such as first-in-first-out, most-idle-agent or least-active-agent, scenario-based or rules-based pairing, or other non-AI/ML pairing techniques in situations where APPL 107 is unable to provide pairing indications, situations where APPL 107 is unavailable or unreachable, in situations where a queue state is within one or more thresholds (e.g., when a queue of unmatched support requests includes fewer than a threshold quantity of requests), or the like.

Additionally, in some embodiments, TAPCEL 109 may make pairing selections between support requestors 103 and respective support agents 105 in one or more surplus scenarios. In one example surplus scenario, a surplus of support agents 105 may be present, in which one or more support agents 105 are in an “idle” state (e.g., are not currently assigned to handle an open or active support request). In such scenarios, TAPCEL 109 may pair an incoming support request with a particular support agent 105 who has been idle for the longest duration of time. For example, TAPCEL 109 may make such selection, in some embodiments, without forwarding a request for a pairing recommendation to APPL 107.

The impact of utilizing AI/ML-based techniques to select support agents 105 for handling support requests, in accordance with some embodiments, may be measurable and dramatic, as compared to implementations that do not utilize such techniques. In one example, to measure the performance or impact of the AI/ML-based techniques of some embodiments, performance or satisfaction metrics that result from routing support requests via AI/ML-based techniques may be computed and normalized by the number of support requests to compute per-request performance or satisfaction metrics. Similarly, per-request performance or satisfaction metrics may be computed by computing such metrics support requests routed or matches via first-in-first-out techniques or other non-AI/ML techniques. The difference between these respective metrics may be considered to be the marginal benefit of routing support requests using AI/ML-based techniques. The per-request metrics may be applied over an estimated or predicted lifecycle of a given support requestor 103, in order to compute the performance impact of the AI/ML-based techniques on a per-support requestor 103 basis.

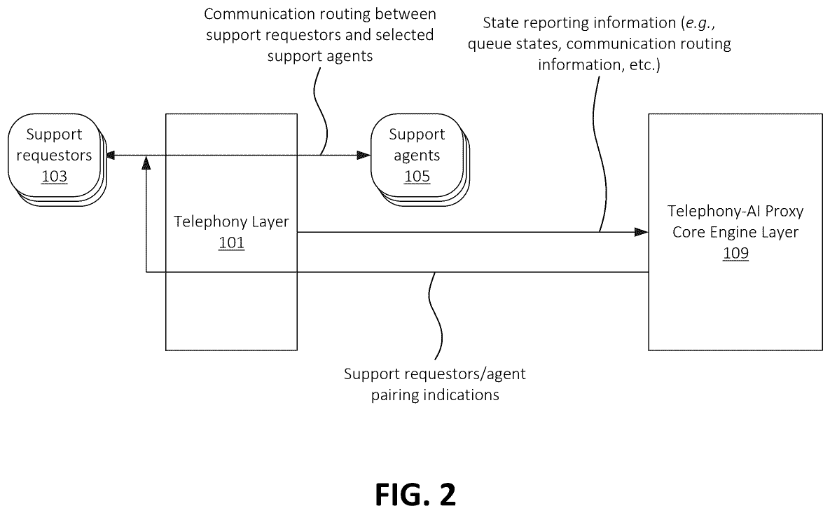

As shown in FIG. 2, TL 101 may facilitate communications between particular support requestors 103 and support agents 105. The communications may include voice-based communications (e.g., voice calls), video-based communications (e.g., video calls or videoconferences), messaging communications (e.g., Short Message Service (“SMS”) messaging, application-based messaging, or the like), and/or other suitable types of communications. TL 101 may also maintain or report state information associated with support requestors 103, support agents 105, and/or communications between respective support requestors 103 and support agent 105. For example, TL 101 may include or implement one or more application programming interfaces (“APIs”), software development kits (“SDKs”), frameworks, adapters, or the like, via which TL 101 may provide state reporting information to one or more other devices or systems, such as TAPCEL 109.

TL 101 may further provide, to TAPCEL 109, information indicating requests received (e.g., from particular support requestors 103), which may include requests to match or pair a given support requestor 103 with an optimal support agent 105. The state reporting information provided by TL 101 to TAPCEL 109 may further include, for example, queue state information relating to a queue of support requests that have been received but not yet handled (e.g., not yet routed or forwarded to a given support agent 105), which may include a duration of time that each support request has remained in the queue. TL 101 may provide the state reporting information to TAPCEL 109 on a periodic basis, an intermittent basis, and/or on some other ongoing basis.

As discussed below, TAPCEL 109 may provide pairing indications (e.g., pairing a given support requestor 103 with a particular support agent 105 based on one or more suitable factors) to TL 101, based on which TL 101 may facilitate communications between such support requestor 103 and support agent 105. Facilitating such communications may, for example, include matching up a support request with an optimal support agent 105, in order to optimize factors such as user satisfaction of support requestors 103, time spent to resolve support requests, and/or overall efficiency of a support system utilizing such embodiments.

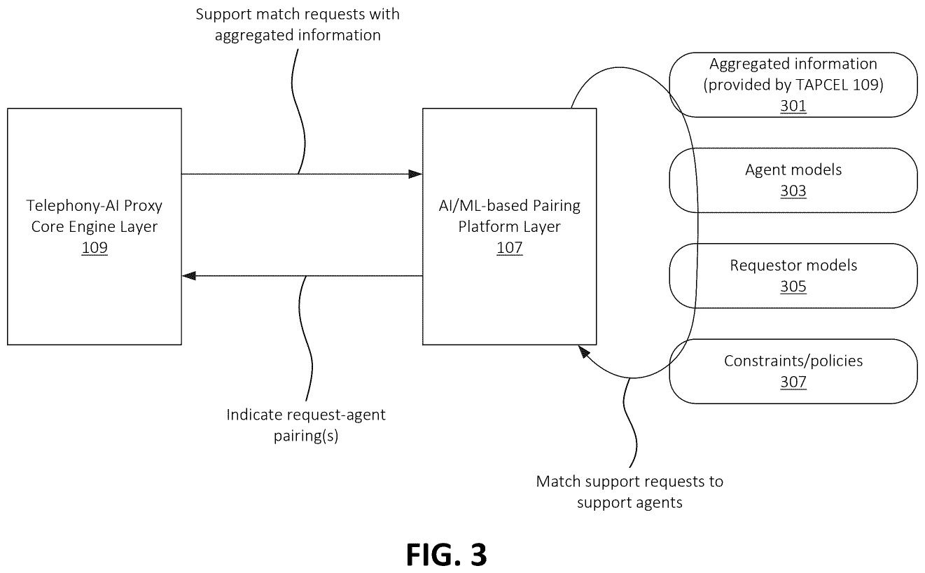

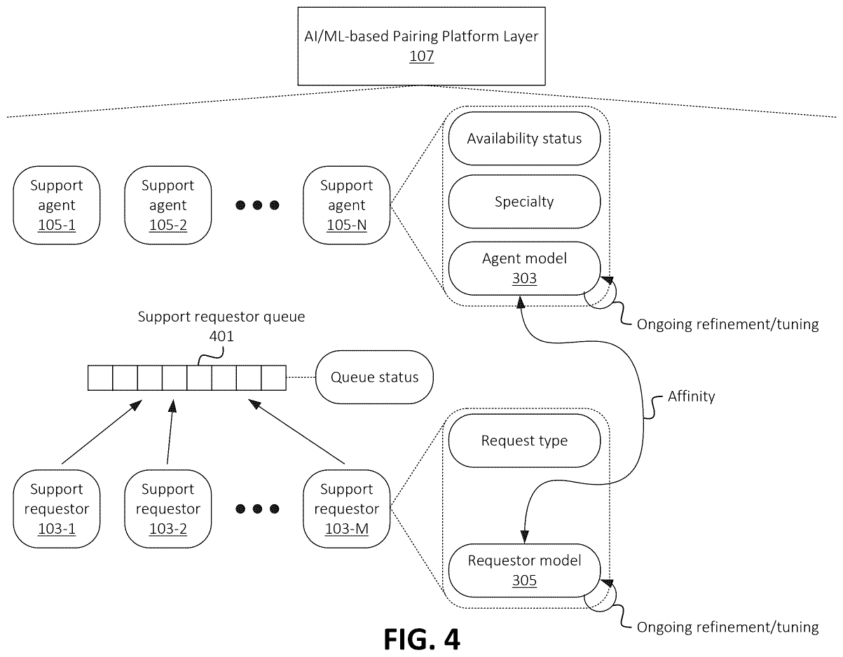

As shown in FIG. 3, for example, TAPCEL 109 may receive the pairing indications from APPL 107 based on match requests sent by TAPCEL 109 to APPL 107. As discussed above, and referring also to FIG. 4, the match requests may include aggregated information 301, such as availability status of one or more support agents 105 (e.g., available or unavailable to handle support requests), specialty or area of expertise, and/or other suitable information. In some embodiments, APPL 107 may receive such information from one or more other information sources (e.g., other than TAPCEL 109). In some embodiments, aggregated information 301 may include information extracted from or otherwise determined based on a content of a given support request, such as key words or phrases (e.g., identified using voice recognition for support requests received via voice call), a computed or processed intent of a support request, temporal information associated with a support request (e.g., date, time, etc.), and/or other suitable information.

As further shown in FIGS. 3 and 4, APPL 107 may generate or receive one or more agent models 303, which may include one or more AI/ML models that may be used to classify, categorize, represent, etc. attributes of particular support agents 105. Agent models 303 may be refined over time using supervised or unsupervised learning, neural networks, random forest models, and/or other suitable types of AI/ML or other modeling techniques. Agent models 303 may include or may be based on, for example, outcomes associated with respective support agents 105 such as user satisfaction scores (e.g., based on post-support interaction surveys) or time to complete support requests, measures of agent attentiveness scores, measures of agent personality or temperament scores, agent experience (e.g., tenure or quantity of support requests handled), amount of agent activity in a given timeframe (e.g., in order to avoid underutilizing or overutilizing any given support agent 105), and/or other measures of performance. In some embodiments, the generating and/or refining of agent models 303 may be performed based on outcomes of actual, real-world support requests. Additionally, or alternatively, APPL 107 may generate and/or refine agent models 303 based on performing one or more simulations.

As further shown in FIG. 4, aggregated information 301 may include support requestor queue information 401, which may indicate a queue state of support requests received from one or more support requestors 103. Although support requestor queue information 401 may indicate a particular sequence of support requests (e.g., where the sequence is keyed to the time at which respective support requests were received), the support requests may ultimately be filled or matched in a different sequence, such as when an optimal match between a particular support request and a respective support agent 105 is determined. In some embodiments, TAPCEL 109 may provide support requestor queue information 401 on an ongoing basis, such as on a periodic basis, an intermittent basis, an event-driven basis (e.g., each time one or more support requests are received), and/or on some other suitable basis. In this manner, APPL 107 may remain up-to-date as to the status of the queue. In some embodiments, support requestor queue information 401 may relate to multiple queues, such as multiple queues that are associated with different requests types, categories or groups of support requestors 103, etc. In one implementation, an interactive voice response (“IVR”) system may be used to handle incoming support requests, and selections via an IVR menu may be used to separate the queues. For example, one queue may be associated with one support request type (and one associated IVR menu selection), while another queue may be associated with another support request type (and another associated IVR menu selection).

APPL 107 may further generate or refine one or more requestor models 305, that include attributes that may be used to classify, categorize, etc. respective support requestors 103 from which support requests are received. For a given support request, APPL 107 may identify a corresponding requestor model. The attributes may include, for example, requestor location, requestor category (e.g., enterprise, first responder, home user, etc.), measures of requestor personality and/or temperament, how often support requestor 103 submits support requests, device type, etc. In some embodiments, the generating and/or refining of requestor models 305 may be performed based on outcomes of actual, real-world support requests. Additionally, or alternatively, APPL 107 may generate and/or refine requestor models 305 based on performing one or more simulations. Although shown as separate models, in some embodiments, agent models 303 and requestor models 305 may be implemented as a single unified model.

APPL 107 may further identify or maintain affinity information between models, such as agent models and requestor models. The affinity information may indicate a weight or preference for support agents 105, having certain attributes (e.g., meeting attributes specified in a given agent model), to be paired with particular request types and/or requestor models. In this sense, support agents 105 that meet attributes of other support agents 105 that have provided a relatively high measure of success or have achieved relatively favorable outcomes in the past may be paired with support requestors 103 that have received such high measure of success or relatively favorable outcomes in the past. In some embodiments, the generating and/or refining of affinity information between agent models 303 and requestor models 305 (and/or other affinity information) may be performed based on outcomes of actual, real-world support requests. Additionally, or alternatively, APPL 107 may generate and/or refine affinity information based on performing one or more simulations.

APPL 107 may further receive or maintain one or more constraints and/or policies 307, such as a requirement that a particular support requestor 103 be matched with a particular support agent 105, a requirement that support requestors 103 meeting a particular requestor model 305 be matched with support agents 105 meeting a particular agent model 303, a maximum wait time (e.g., an amount of time that a support request is permitted to remain in a queue while an AI/ML-based selection process matches the support request to a respective support agent 105, and after which a different selection process may be used such as a first-in-first-out selection process), and/or other suitable constraints and/or policies.

In some embodiments, APPL 107 may utilize one AI/ML model or AI/ML-based algorithm to pair support requests (e.g., from support requestors 103) to respective support agents 105. In some embodiments, APPL 107 may utilize multiple AI/ML models or algorithms to pair support requests to respective support agents 105 (e.g., in order to avoid the possibility of one particular model having a disproportionate impact on the overall system). In some embodiments, different AI/ML models or AI/ML-based algorithms may be used in different situations. For example, in an agent surplus situation (e.g., in which more agents are available than are needed to handle all support requests in one or more queues), a first set of AI/ML models or AI/ML-based algorithms may be used. On the other hand, in a requestor surplus situation (e.g., in which fewer agents are available than are needed to handle all support requests in one or more queues), a second set of AI/ML models or AI/ML-based algorithms may be used.

In some embodiments, when performing a pairing process to pair support requests with optimal support agents 105, APPL 107 may delay making a pairing determination in some scenarios. For example, if a given support request is associated with a relatively low affinity, a relatively low likelihood of successful outcome, or the like for available support agents 105, and would be associated with a relatively higher affinity and/or a higher likelihood of measure of successful outcome with other support agents 105 (e.g., where such support agents 105 may currently be unavailable due to handling other support requests), APPL 107 may delay pairing the support request until a given support agent 105, with a higher likelihood of successful outcome, becomes available. In some embodiments, APPL 107 may delay pairing decisions until a particular threshold quantity of support agents 105 become available (e.g., create an agent surplus on an ongoing basis). In this manner, APPL 107 may, on an ongoing basis, maintain a higher pool of support agents 105 to select from, thus potentially increasing the overall likelihood of successful outcome for received support requests (e.g., as opposed to constraining the selections only to immediately available support agents 105). In some examples, APPL 107 may select a “default” or “fallback” pairing process, such as a first-in-first out pairing process, in situations where at least a threshold measure of successful outcomes is not attainable under current conditions (e.g., if all support agents for a given specialty are currently occupied, and a set of support requests are associated with such specialty and would be required to wait a potentially relatively long duration of time in order to be paired with such support agents).

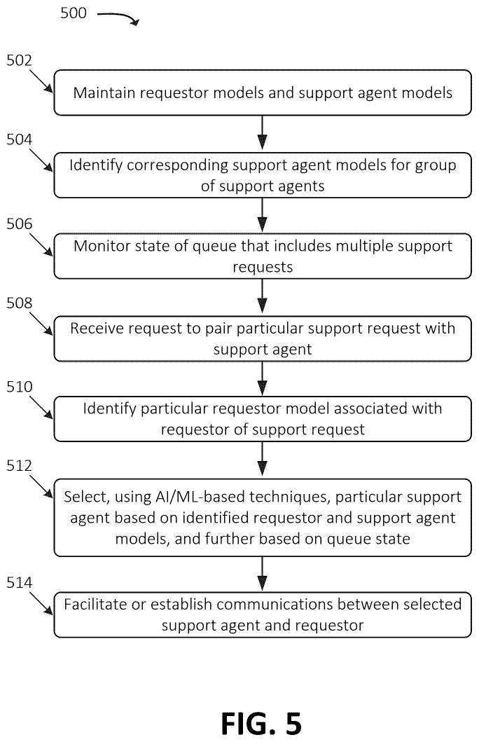

FIG. 5 illustrates an example process 500 for utilizing automated techniques to pair support requests with support agents. In some embodiments, some or all of process 500 may be performed by a support routing platform, which may be a device or system that includes TL 101, APPL 107, and TAPCEL 109.

As shown, process 500 may include maintaining (at 502) respective sets of requestor models and support agent models. For example, as discussed above, the support routing platform (e.g., APPL 107 of the support routing platform) may receive, maintain, generate, refine, etc. agent models 303 and requestor models 305. Agent models 303 and requestor models 305 may, as discussed above, be generated or refined based on real-world interactions between requestors who submit support requests and support agents who assist with resolving such requests. Additionally, or alternatively, agent models 303 and requestor models 305 may be generated or refined based on simulated interactions between requestors who submit support requests and support agents who assist with resolving such requests.

Process 500 may further include identifying (at 504) corresponding support agent models for a group of support agents. For example, for a given support agent, APPL 107 may classify such support agent as being associated with a particular agent model 303. In some embodiments, APPL 107 may identify other attributes of some or all of the support agents, such as an availability status, a support subject matter specialty, and/or other suitable information.

Process 500 may additionally include monitoring (at 506) the state of a queue that includes multiple support requests. For example, APPL 107 may receive, from TAPCEL 109 and/or TL 101, information specifying a sequence of support requests that have been received, where the sequence is based on when the support requests were received, and a first support request received prior to a second support request may be considered as being “ahead of” or “before” the second support request in the sequence. Similarly, the second support request received after the first support request may be considered as being “later than” or “after” the second support request in the sequence.

Process 500 may also include receiving (at 508) a request to pair a particular support request with a particular support agent. For example, APPL 107 may receive (e.g., from TAPCEL 109) a request to match some or all of the support requests, in the queue, with respective support agents (and/or may otherwise identify that some or all of the support requests should be matched with respective support agents).

Process 500 may further include identifying (at 510) a particular requestor model associated with a particular requestor that has provided a particular support request. For example, APPL 107 may receive attributes or other information associated with a given requestor, and may identify a corresponding requestor model 305 for the requestor. In some embodiments, APPL 107 may receive other attributes or characteristics of the request, such as a type of request, subject matter of the request, or the like.

Process 500 may additionally include selecting (at 512), using AI/ML-based techniques, a particular support agent based on the identified requestor model 305, one or more agent models 303 associated with a set of support agents, and the queue status. For example, APPL 107 may identify particular support agent that is associated with a particular agent model 303 that has a high measure of affinity with the identified requestor model 305. Additionally, or alternatively, APPL 107 may identify a particular support agent that has a specialty or area of expertise that matches or otherwise satisfies the type or subject matter of the request. In some embodiments, APPL 107 may utilize wait time or queue position of the request as a factor in the selection of the particular support agent.

Process 500 may also include facilitating or establishing (at 514) a communication session between the selected support agent and the requestor. For example, APPL 107 may output an instruction (e.g., to TL 101) to connect the requestor with the support agent, such as via a voice call, a text-based messaging session, and/or some other type of suitable communication session.

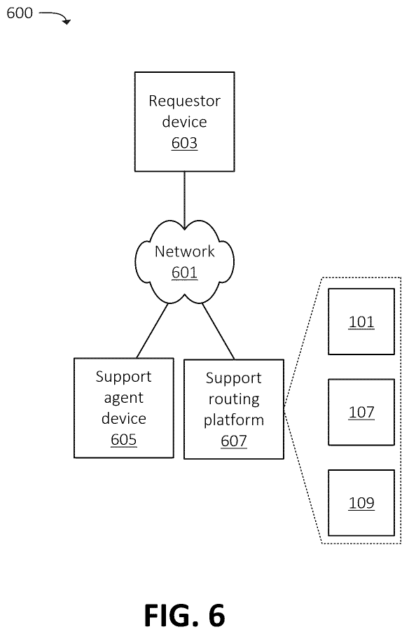

FIG. 6 illustrates an example environment 600, in which one or more embodiments may be implemented. Environment 600 may include network 601, requestor devices 603, support agent devices 605, and support routing platform 607 (e.g., which may include or implement TL 101, APPL 107, and TAPCEL 109). In some embodiments, environment 600 may include one or more additional devices or systems communicatively coupled to network 601 and/or one or more other networks.

The quantity of devices and/or networks, illustrated in FIG. 6, is provided for explanatory purposes only. In practice, environment 600 may include additional devices and/or networks, fewer devices and/or networks, different devices and/or networks, or differently arranged devices and/or networks than illustrated in FIG. 6. For example, while not shown, environment 600 may include devices that facilitate or enable communication between various components shown in environment 600, such as routers, modems, gateways, switches, hubs, etc. In some implementations, one or more devices of environment 600 may be physically integrated in, and/or may be physically attached to, one or more other devices of environment 600. Alternatively, or additionally, one or more of the devices of environment 600 may perform one or more network functions described as being performed by another one or more of the devices of environment 600. Elements of environment 600 may interconnect with each other and/or other devices via wired connections, wireless connections, or a combination of wired and wireless connections. Some or all of the elements of environment 600 may be implemented by one or more devices, sets of hardware resources, cloud systems, or the like.

Network 601 may include one or more wired and/or wireless networks. For example, network 601 may include an IP-based Packet Data Network (“PDN”), a wide area network (“WAN”) such as the Internet, a private enterprise network, and/or one or more other networks. One or more requestor devices 603, support agent devices 605, support routing platform 607, and/or other devices or systems may communicate, through network 601, with each other and/or with other devices that are coupled to network 601. Network 601 may be connected to one or more other networks, such as a public switched telephone network (“PSTN”), a public land mobile network (“PLMN”), and/or another network. Network 601 may be connected to one or more devices, such as content providers, applications, web servers, and/or other devices, with which requestor devices 603, support agent devices 605, support routing platform 607, and/or other devices or systems may communicate.

Requestor devices 603, support agent devices 605, support routing platform 607, and/or other devices or systems may be implemented by one or more cloud systems, server devices, or other types of hardware resources. In some embodiments, requestor devices 603, support agent devices 605, and support routing platform 607 may be implemented by or communicatively coupled to a User Equipment (“UE”), which may include a computation and communication device, such as a wireless mobile communication device that is capable of communicating with network 601. The UE may communicate with network 601 via a wired or a wireless interface, such as via one or more radio access network (“RANs”), such as a Fifth Generation (“5G”) RAN, a Long-Term Evolution (“LTE”) RAN, etc. The UE may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an IoT device (e.g., a sensor, a smart home appliance, a wearable device, a Machine-to-Machine (“M2M”) device, or the like), a Fixed Wireless Access (“FWA”) device, or another type of mobile computation and communication device. Support routing platform 607 may include or may implement the functionality of TL 101, APPL 107, and TAPCEL 109, in some embodiments.

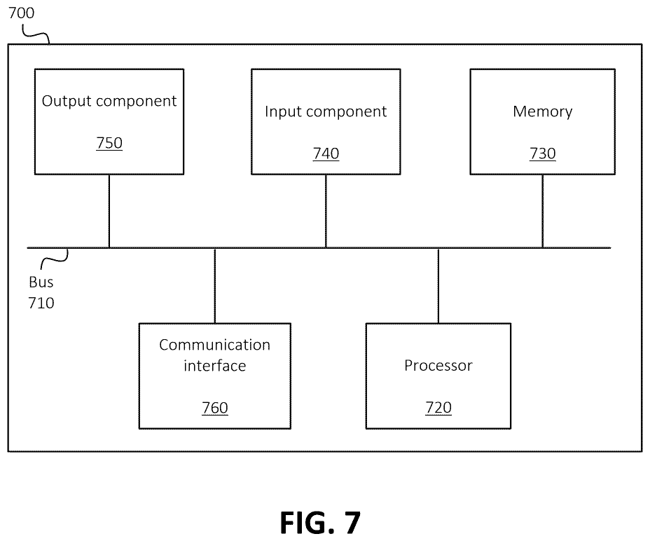

FIG. 7 illustrates example components of device 700. One or more of the devices described above may include one or more devices 700. Device 700 may include bus 710, processor 720, memory 730, input component 740, output component 750, and communication interface 760. In another implementation, device 700 may include additional, fewer, different, or differently arranged components.

Bus 710 may include one or more communication paths that permit communication among the components of device 700. Processor 720 may include a processor, microprocessor, a set of provisioned hardware resources of a cloud computing system, a graphics processing unit (“GPU”), a GPU-based processing unit, a neural processing unit (“NPU”), or other suitable type of hardware that interprets and/or executes instructions (e.g., processor-executable instructions). In some embodiments, processor 720 may be or may include one or more hardware processors. Memory 730 may include any type of dynamic storage device that may store information and instructions for execution by processor 720, and/or any type of non-volatile storage device that may store information for use by processor 720.

Input component 740 may include a mechanism that permits an operator to input information to device 700 and/or other receives or detects input from a source external to input component 740, such as a touchpad, a touchscreen, a keyboard, a keypad, a button, a switch, a microphone or other audio input component, etc. In some embodiments, input component 740 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 750 may include a mechanism that outputs information to the operator, such as a display, a speaker, one or more light emitting diodes (“LEDs”), etc.

Communication interface 760 may include any transceiver-like mechanism that enables device 700 to communicate with other devices and/or systems (e.g., via RAN $a10, RAN $a12, DN $a50, etc.). For example, communication interface 760 may include an Ethernet interface, an optical interface, a coaxial interface, or the like. Communication interface 760 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 700 may include more than one communication interface 760. For instance, device 700 may include an optical interface, a wireless interface, an Ethernet interface, and/or one or more other interfaces.

Device 700 may perform certain operations relating to one or more processes described above. Device 700 may perform these operations in response to processor 720 executing instructions, such as software instructions, processor-executable instructions, etc. stored in a computer-readable medium, such as memory 730. A computer-readable medium may be defined as a non-transitory memory device. A memory device may include space within a single physical memory device or spread across multiple physical memory devices. The instructions may be read into memory 730 from another computer-readable medium or from another device. The instructions stored in memory 730 may be processor-executable instructions that cause processor 720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-5), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
maintain a set of requestor models;
maintain a set of support agent models;
identify, for each support agent of a plurality of support agents, a corresponding support agent model;
monitor a state of a queue that includes a plurality of support requests;
receive a request to pair a particular support request, of the plurality of support requests, with a support agent, wherein the particular support request is received from a particular requestor;
identify a particular requestor model associated with the particular support request;
select, based on the particular requestor model, the particular support agent model, and the state of the queue, a particular support agent; and
establish a communication session between the selected particular support agent and the particular requestor.

2. The device of claim 1, wherein the one or more processors are further configured to:
generate or refine the set of requestor models and the set of support agent models using artificial intelligence/machine learning (“AI/ML”) techniques.

3. The device of claim 1, wherein the one or more processors are further configured to:
maintain measures of affinity between respective requestor models and support agent models, wherein selecting the particular support agent is further based on a particular measure of affinity between the particular support agent model and the particular requestor model.

4. The device of claim 1, wherein the communication session between the selected particular support and the particular requestor includes a voice call.

5. The device of claim 1, wherein the set of requestor models includes a set of requestor that has been generated or refined based on interactions between a plurality of requestors and one or more support agents of the plurality of support agents.

6. The device of claim 1, wherein the particular support request is a first support request, wherein the queue includes a particular sequence of requests, wherein the first support request is later in the particular sequence than a second support request, wherein the communication session is established between the selected particular support agent and the particular requestor prior to a selection procedure to select a support agent for the second support request.

7. The device of claim 1, wherein the requestor models and the agent models are generated or refined based on simulated interactions between requestors and support agents.

8. A non-transitory computer-readable medium, storing a plurality of processor-executable instructions to:
maintain a set of requestor models;
maintain a set of support agent models;
identify, for each support agent of a plurality of support agents, a corresponding support agent model;
monitor a state of a queue that includes a plurality of support requests;
receive a request to pair a particular support request, of the plurality of support requests, with a support agent, wherein the particular support request is received from a particular requestor;
identify a particular requestor model associated with the particular support request;
select, based on the particular requestor model, the particular support agent model, and the state of the queue, a particular support agent; and
establish a communication session between the selected particular support agent and the particular requestor.

9. The non-transitory computer-readable medium of claim 8, wherein the plurality of processor-executable instructions further include processor-executable instructions to:
generate or refine the set of requestor models and the set of support agent models using artificial intelligence/machine learning (“AI/ML”) techniques.

10. The non-transitory computer-readable medium of claim 8, wherein the plurality of processor-executable instructions further include processor-executable instructions to:
maintain measures of affinity between respective requestor models and support agent models, wherein selecting the particular support agent is further based on a particular measure of affinity between the particular support agent model and the particular requestor model.

11. The non-transitory computer-readable medium of claim 8, wherein the communication session between the selected particular support and the particular requestor includes a voice call.

12. The non-transitory computer-readable medium of claim 8, wherein the set of requestor models includes a set of requestor that has been generated or refined based on interactions between a plurality of requestors and one or more support agents of the plurality of support agents.

13. The non-transitory computer-readable medium of claim 8, wherein the particular support request is a first support request, wherein the queue includes a particular sequence of requests, wherein the first support request is later in the particular sequence than a second support request, wherein the communication session is established between the selected particular support agent and the particular requestor prior to a selection procedure to select a support agent for the second support request.

14. The non-transitory computer-readable medium of claim 8, wherein the requestor models and the agent models are generated or refined based on simulated interactions between requestors and support agents.

15. A method, comprising:
maintaining a set of requestor models;
maintaining a set of support agent models;
identifying, for each support agent of a plurality of support agents, a corresponding support agent model;
monitoring a state of a queue that includes a plurality of support requests;
receiving a request to pair a particular support request, of the plurality of support requests, with a support agent, wherein the particular support request is received from a particular requestor;
identifying a particular requestor model associated with the particular support request;
selecting, based on the particular requestor model, the particular support agent model, and the state of the queue, a particular support agent; and
establishing a communication session between the selected particular support agent and the particular requestor.

16. The method of claim 15, further comprising:
generating or refining the set of requestor models and the set of support agent models using artificial intelligence/machine learning (“AI/ML”) techniques.

17. The method of claim 15, further comprising:
maintaining measures of affinity between respective requestor models and support agent models, wherein selecting the particular support agent is further based on a particular measure of affinity between the particular support agent model and the particular requestor model.

18. The method of claim 15, wherein the communication session between the selected particular support and the particular requestor includes a voice call.

19. The method of claim 15, wherein the set of requestor models includes a set of requestor that has been generated or refined based on interactions between a plurality of requestors and one or more support agents of the plurality of support agents.

20. The method of claim 15, wherein the particular support request is a first support request, wherein the queue includes a particular sequence of requests, wherein the first support request is later in the particular sequence than a second support request, wherein the communication session is established between the selected particular support agent and the particular requestor prior to a selection procedure to select a support agent for the second support request.
